(19) United States
(12) Patent Application Publication
(10) Pub. No.: US 2013/0134293 A1
(43) Pub. Date: May 30, 2013

(54) OPTICAL EXAMINATIONS WITH CONTROLLED INPUT LIGHT

(71) Applicants: Jacobus Hermanus Maria Neijzen, Heeze (NL); Jacobus Maria Antonius Van Den Eerenbeemd, Nuenen (NL); Johannes Joseph Hubertina Barbara Schleipen, Eindhoven (NL)

(72) Inventors: Jacobus Hermanus Maria Neijzen, Heeze (NL); Jacobus Maria Antonius Van Den Eerenbeemd, Nuenen (NL); Johannes Joseph Hubertina Barbara Schleipen, Eindhoven (NL)

(73) Assignee: KONINKLIJKE PHILIPS ELECTRONICS N.V., EINDHOVEN (NL)

(21) Appl. No.: 13/581,696

(22) PCT Filed: Feb. 24, 2011
(86) PCT No.: PCT/IB2011/050780

§ 371 Date: Oct. 3, 2012

(30) Foreign Application Priority Data
Mar. 2, 2010 (EP) 10155155.4

(51) Int. Cl. G01J 1/42

(52) U.S. Cl. CPC G01J 1/42
USPC 250/201.1; 250/216

(57) ABSTRACT

The invention relates to a sensor device (100) in which the spatial distribution of an input light (L1) emission from a light emitting area (121, 122) of a light source (120) can selectively be changed. The input light is propagated through an optical system (110) to produce some output light (L2). Changes of the input light are taken into account when the detected output light (L2) is evaluated. Thus it is for example possible to detect and/or eliminate optical disturbances occurring in the optical path outside an object region (3). The light source (120) may particularly comprise a plurality of a light emitting segments (121, 122) that can selectively be switched on or off.

### FIELD OF THE INVENTION

The invention relates to an optical sensor device comprising and light source, an optical system, a light detector, and an evaluation unit for evaluating light after passage through the optical system. Moreover, it relates to a method for making examinations with an optical sensor device and to uses of the sensor device.

### BACKGROUND OF THE INVENTION

The WO 2008/155716 discloses an optical biosensor in which input light is totally internally reflected and the resulting output light is detected and evaluated with respect to the amount of target components at the reflection surface. The target components comprise magnetic particles as labels, which allows to affect the processes in the sample by magnetic forces. Disturbances in the light path are taken into account by estimating the amount of light that propagates outside a “nominal light path”.

### SUMMARY OF THE INVENTION

Based on this background it was an object of the present invention to provide alternative means for making optical examinations which are robust with respect to inevitable disturbances in the optical pathway.

This object is achieved by an optical sensor device according to claim 1, a method according to claim 2, and a use according to claim 15. Preferred embodiments are disclosed in the dependent claims.

According to its first aspect, the invention relates to an optical sensor device that comprises the following components:
A light source with a light emitting area, wherein the light emitted from this area will in the following be called “input light” for purposes of reference (indicating that it is used as an input into the optical system mentioned below). The light emitting area shall have the characteristic feature that the spatial distribution of its input-light emission can selectively be changed. The light emitting area may for example consist of several parts for which light emission can selectively be switched on or off.
An optical system through which the aforementioned input light emitted by the light source can propagate to yield an emission of “output light” from the optical system. The optical system may have many different designs, depending on the particular application it is intended for. Moreover, the output light that is emitted by the optical system shall be related to (or caused by) the input light in a general sense. The output light may for example comprise (or consist of) photons of the input light after their passage through the optical system. Additionally or alternatively, the output light may comprise other photons that are directly or indirectly generated by the input light, for instance photons of fluorescence that was stimulated by the input light. In any case, there will be some more or less pronounced dependence of the output light on the aforementioned changes of the input light.
A light detector for detecting the aforementioned output light emitted by the optical system. The detector may comprise any suitable sensor or plurality of sensors by which light of a given spectrum can be detected, for example photodiodes, photo resistors, photocells, a CCD chip, or a photo multiplier tube.
An evaluation unit for evaluating the output light that was detected by the light detector, wherein said evaluation shall take the mentioned changes of the input light into account. The evaluation unit may particularly be realized by dedicated electronic hardware, digital data processing hardware with associated software, or a mixture of both.

According to a second aspect, the invention relates to a method for making examinations with an optical sensor device, particularly a sensor device of the kind defined above. The method comprises the following steps:
Emitting input light from a light emitting area of a light source, wherein the spatial distribution of the input-light emission from said area is selectively changed.
Propagating said input light through an optical system to yield an emission of output light.
Detecting said output light with a light detector.
Evaluating the detected output light while taking the changes of the input light into account.

The sensor device and the method according to the first and second aspect of the invention make use of deliberate changes of an input light, more precisely of changes in the spatial distribution of the input-light emission from a light source, in order to effect changes in the output light of an optical system which can be taken into account when said output light is evaluated. This approach turns out to be very useful because the different configurations of the input light disclose information about the conditions in the optical system that are obscured when a (spatially) constant illumination is used. Hence it is possible to extract such information with the evaluation unit and to exploit it for different purposes, some of which will be explained in more detail below with reference to particular embodiments of the invention.

In the following, various preferred embodiments of the invention will be described that relate to both the sensor device and the method defined above.

According to a first preferred embodiment, the sensor device comprises a control unit that is coupled to both the light source and the evaluation unit. The control unit may for example be realized in dedicated electronic hardware and/or digital data processing hardware with associated software. Moreover, it may preferably be integrated into the evaluation unit. The control unit can be used to control the changes in the spatial distribution of the input-light emission of the light source according to a predetermined (e.g. user specified) schedule, wherein the control information may additionally be made available to the evaluation unit. The evaluation unit can thus attribute changes observed in the detected output light to changes induced in the input light by the control unit.

According to a further development of the invention, the sensor device comprises a control unit (particularly the control unit according to the aforementioned embodiment) that is adapted to repetitively switch between different spatial patterns of light emission from the light emitting area of the light source. Using a limited number of light emission patterns that are repetitively used allows to base the evaluation of the detected output light on a repertoire of standard scenarios.

The changes in the spatial distribution of the input-light emission can affect different parameters of the emission. Some examples of possible parameters are given in the following, wherein these parameters may be changed solely or in any combination.

A particularly important changeable parameter is the intensity of the light emission, the simplest case being that light emission of a sub-area is switched on or off. In a more elaborate embodiment, changes of the light intensity may occur in a plurality of steps and/or continuously.

Another example of an emission parameter that may be changed is the wavelength of the emitted light, or, more precisely, its spectral composition. Different selectively controlled parts of the light emitting area might for example emit in red, green, blue, or other colors.

A further example of a light emission parameter is the polarization of the emitted light, allowing for example changes between non-polarized, linearly polarized (with some given direction), circularly polarized etc.

Depending on the construction of the light source, there are different ways to achieve changes in the spatial distribution of the input-light emission. According to a preferred embodiment, the light emitting area of the light source comprises a plurality of segments that can individually be controlled. Hence a spatial variation of the light emission can be achieved by simply switching different segments on or off, without a need for moving mechanical parts.

According to a further development of the aforementioned embodiment, the segments of the light emitting area are arranged in a one- or two-dimensional matrix pattern. The most simple matrix may consist of just two neighboring segments, while elaborate configurations may consist of a huge number of light emitting spots (or pixels). In another design, segments are arranged in concentric rings. Such an embodiment is particularly suited if a rotational symmetry of the whole optical setup about an optical axis shall be preserved.

It was already mentioned that the optical system may have many different designs according to the particular application the sensor device is used for. An important class of embodiments is characterized by the fact that the optical system comprises some (one-, two- or three-dimensional) region which is imaged (mapped) onto the light detector. This particular region will in the following be called “object region” for purposes of reference, indicating that often an object to be investigated is arranged in this region. A purpose of the sensor device is usually to a detect some information about a sample in the object region based on its interactions with the input light.

According to a further development of the aforementioned embodiment, the evaluation of the detected output light that takes place in the evaluation unit comprises the detection and/or the elimination of optical disturbances outside the object region. This embodiment takes the fact into account that, in optical systems with an object region, the processes in the object region are usually the only thing of interest, while optical interactions outside the object region should ideally have constant properties. The latter condition is however in practice not realizable due to inevitable random disturbances by dust, misalignment of optical components, scratches on optical surfaces, thermal expansion of components etc. Detecting such disturbances outside the object region may for example be used for quality control in the production of sensor devices. Elimination of the disturbances may be used to improve measurement results obtained with the sensor device.

In another embodiment of a sensor device with an object region in the optical system, the evaluation of the detected output light comprises the determination of the sensitivity of image parts to changes of the input light. This approach is based on the fact that the image of the object region on the light detector is usually constant irrespective of the induced spatial changes of the input light (which is due to the particular design of the optical system), while regions of the optical system away from the object region will have effects on the image generated in the light detector that considerably depend on the configuration of the input light. Parts of the image in the light detector that are very sensitive to changes of the input light will hence reveal influences from outside the object region, i.e. from disturbances which should be detected and/or eliminated.

According to another embodiment of the invention, the physical interaction of input light with a sample in the optical system (e.g. a sample in the above-mentioned object region) changes with the induced changes of the input light. In contrast to the aforementioned embodiment, in which changes of input light should have little or no effect on the processes in the object region, the now considered embodiment exploits just such dependences of the physical interaction on the configuration of the input light. Changes of the spatial distribution of the input-light emission provide in this case an easily controllable means for varying the manipulation of a sample.

It was already mentioned that the input light may be subject to various optical processes in the optical system. In particular, the input light may be reflected, refracted, scattered and/or absorbed in the optical system. Most preferably, these processes take place in interaction with some sample that shall be manipulated and/or investigated.

According to a preferred embodiment of the invention, the sensor device is designed in such a way that the input light is totally internally reflected at an interface in the optical system. Most preferably, said interface comprises an object region of the kind discussed above, where input light can interact with an adjacent sample. This may lead to frustrated total internal reflection (FTIR), wherein the resulting output light provides useful information about the sample.

In another preferred embodiment of the invention, the sensor device is designed in such a way that the input light is multiple times refracted at an interface with a prismatic structure. In this case a sample contacting said prismatic structure is reached by the input light in a well controllable manner.

The invention further relates to the use of the device described above for molecular diagnostics, biological sample analysis, chemical sample analysis, food analysis, forensic analysis and/or quality control. Molecular diagnostics may for example be accomplished with the help of magnetic particles or fluorescent particles that are directly or indirectly attached to target molecules.

### BRIEF DESCRIPTION OF THE DRAWINGS

These and other aspects of the invention will be apparent from and elucidated with reference to the embodiment(s) described hereinafter. These embodiments will be described by way of example with the help of the accompanying drawings in which:

FIG. 1 shows schematically a side view of a first sensor device using a light source that is segmented in a direction parallel to the plane of the object region;

FIG. 2 shows schematically a top view of the sensor device of FIG. 1;

FIG. 3 shows schematically a side view of a second sensor device using a light source that is segmented in a direction oblique to the plane of the object region;

FIG. 4 shows schematically a top view of the sensor device of FIG. 3;

FIG. 5 illustrates possible patterns of segmentation of the light emitting area of a light source.

Like reference numbers or numbers differing by integer multiples of 100 refer in the Figures to identical or similar components.

### DESCRIPTION OF PREFERRED EMBODIMENTS

Though the present invention will in the following be described with respect to a particular setup (using magnetic particles and frustrated total internal reflection as measurement principle), it is not limited to such an approach and can favorably be used in many different applications and setups.

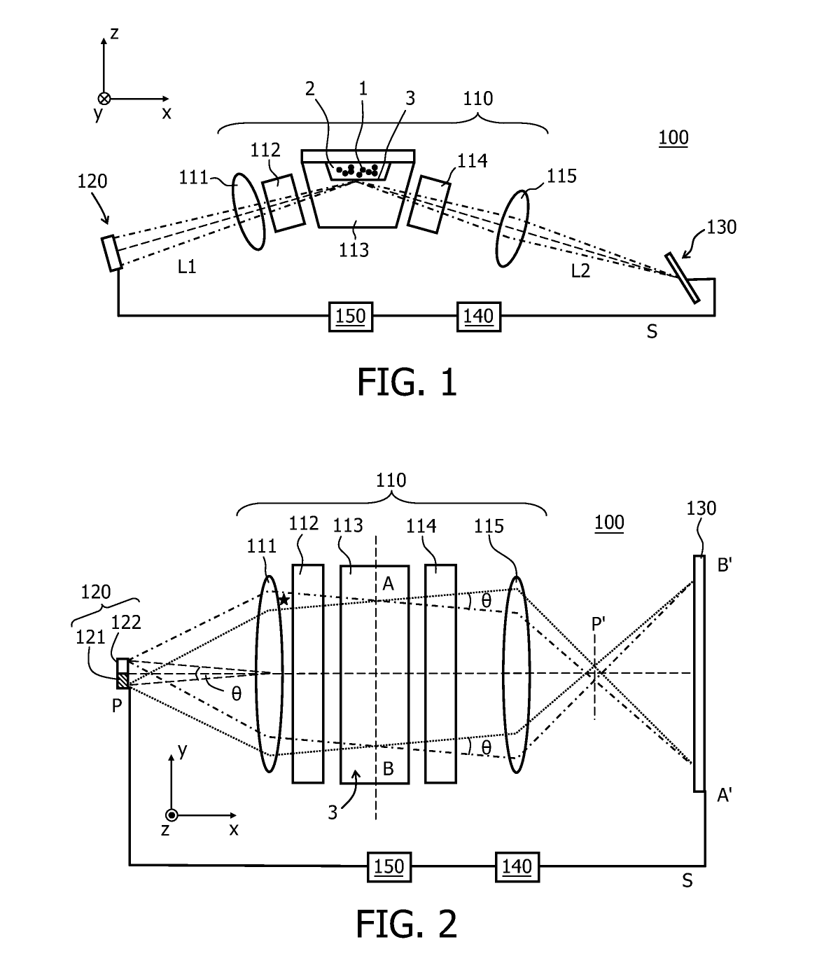

FIG. 1 shows a general setup with a sensor device 100 according to the present invention. A central component of this setup is the (exchangeable) cartridge 113 that may for example be made from glass or transparent plastic like polystyrene. The cartridge 113 contains a sample chamber 2 to which a sample fluid with target components to be detected (e.g. drugs, antibodies, DNA, etc.) can be provided. The sample further comprises magnetic particles, for example superparamagnetic beads, wherein these particles are usually bound (via e.g. a coating with antibodies) as labels to the aforementioned target components. For simplicity only the combination of target components and magnetic particles is shown in the Figure and will be called “target particle 1” in the following. It should be noted that instead of magnetic particles other label particles, for example electrically charged or fluorescent particles, could be used as well.

The lower interface between the cartridge 113 and the sample chamber 2 is formed by a surface called “object region” 3. This object region 3 is coated with capture elements, e.g. antibodies, which can specifically bind to target particles.

The sensor device preferably comprises a magnetic field generator (not shown), for example an electromagnet with a coil and a core, for controllably generating a magnetic field at the object region 3 and in the adjacent space of the sample chamber 2. With the help of this magnetic field, the target particles 1 can be manipulated, i.e. be magnetized and particularly be moved (if magnetic fields with gradients are used). Thus it is for example possible to attract target particles 1 to the object region 3 in order to accelerate their binding to said surface, or to wash unbound target particles away from the object region before a measurement.

The sensor device further comprises a light source 120 that generates input light L1 which is transmitted into the cartridge 113 through a collimator lens 111 and a window 112. As components of the light source 120, e.g. commercial CD (λ=780 nm), DVD (λ=658 nm), or BD (λ=405 nm) laser-diodes or light emitting diodes can be used. The input light L1 arrives at the object region 3 at an angle larger than the critical angle of total internal reflection (TIR) and is therefore totally internally reflected. The reflected light leaves the cartridge 113 through another window 114 and a lens 115 as “output light” L2, which is detected by a light detector 130. The windows 112 and 114 are parts of the readout unit (not of the disposable cartridge) and are used to protect the optics.

The light detector 130 determines the amount of light of the output light L2 (e.g. expressed by the light intensity of this light beam in the whole spectrum or a certain part of the spectrum). The measured sensor signals S are evaluated and optionally monitored over an observation period by an evaluation and recording unit 140 that is coupled to the detector 130. In the shown embodiment, the optical system 110 comprising the lenses 111, 115 is designed such that an image of the object region 3 is generated on the light detector 130. This allows to simultaneously observe processes in different spots of the object region 3. Moreover, the light detector is preferably an image sensor like a CCD or CMOS camera.

It is possible to use the detector 130 also for the sampling of fluorescence light emitted by fluorescent particles which were stimulated by the input light L1, wherein this fluorescence may for example spectrally be discriminated from reflected light. Though the following description concentrates on the measurement of reflected light, the principles discussed here can mutatis mutandis be applied to the detection of fluorescence, too.

For the materials of a typical application, the medium of the cartridge 113 can be glass and/or some transparent plastic with a typical refractive index of 1.52. The medium in the sample chamber 2 will be water-based and have a refractive index close to 1.3. This corresponds to a critical angle of 60°. An angle of incidence of 70° is therefore a practical choice to allow fluid media with a somewhat different refractive index.

The described sensor device 100 applies optical means for the detection of target particles 1. For eliminating or at least minimizing the influence of background (e.g. of the sample fluid, such as saliva, blood, etc.), the detection technique should be surface-specific. As indicated above, this is achieved by using the principle of frustrated total internal reflection (FTIR). This principle is based on the fact that an evanescent wave penetrates (exponentially dropping in intensity) into the sample 2 when the incident light L1 is totally internally reflected. If this evanescent wave then interacts with another medium like the bound target particles 1, part of the input light will be coupled into the sample fluid (this is called “frustrated total internal reflection”), and the reflected intensity will be reduced (while the reflected intensity will be 100% for a clean interface and no interaction). Depending on the amount of target particles on or very near (within about 200 nm) to the TIR surface (not in the rest of the sample chamber 2), the reflected intensity will drop accordingly. This intensity drop is a direct measure for the amount of bound target particles 1, and therefore for the concentration of target particles in the sample.

The aforementioned intensity drop may be expressed as a dimensionless fraction ε of the amount of incident light, wherein ε is typically a very small number. However, the light detector 130 measures the comparatively large residual intensity (1-ε), from which the small signal ε must be determined. Sensitive detection of low concentrations of analytes is therefore possible only if a very small decrease of the reflected light can be detected with sufficient accuracy. To realize such high sensitivity it is needed to compensate for all other factors influencing the detected intensity of the reflected beam apart from the presence of target particles.

One means to achieve this is a TWR (true white reference), i.e. a region of interest (ROI) in the image on the light detector 130 of which the intensity is influenced by all factors that also influence the signal in the detection spot apart from the target particles. A TWR may for instance be realized by a dummy chamber in the object region 3.

In order to increase the sensitivity to a level where the electronic noise in the detection system becomes limiting, the intensity of the TWR must be measured with an accuracy of the order of 1:10⁴. The realization of this accuracy can easily be hampered by a combination of small defects in the image combined with tiny movements of the image. Therefore measures must be taken to avoid defects as much as possible, to suppress the effect of out-of-focus defects (dust, scratches) by increasing the divergence and thereby the effective numerical aperture (NA) of the light beams that illuminate and image the object plane on the detector, and to avoid movement of defects in the image (i.e. by movements of the cartridge 113).

The above considerations are analogously valid for other types of (bio-)sensor devices in which the signal is read out by optical means (for example “DRD”, i.e. double refraction at a surface with prismatic structure, cf. WO 2009/125339 A2). The optical effects, which form the basis of the readout, are angle dependent. This leads to a natural preference for a telecentric optical imaging system (minimal spread in the average angle of the read out beam over the object field) and to reduce the divergence of the read out beam (limited effective NA of the imaging lens).

The imaging system of FIGS. 1 and 2 (with the light source 120, the optical system 110, and the light detector 130) fulfills these criteria for the FTIR systems. Because this system is meant to be used in a handheld application, the total length of the imaging system is preferably as short as possible. The rays in these Figures have been drawn from the perspective of two points A, B in the object plane (object region 3) that are imaged onto points A′ and B′, respectively, on the detector 130. It should be noted that the sub-beams of light emanating from each point of the light source 120 have a common cross section in the object region 3. The area of illumination in the object region 3 (i.e. the area between points A and B) does therefore not change regardless which points of the light source are bright or dark.

A disadvantage in such an imaging system (low NA, telecentric on the object side) is that there is little overlap in the rays corresponding to different image points. Mainly due to the limited NA, imperfections in the plastic of the cartridge 113 or dust particles/scratches on windows/lenses end up as local defects in the image. These unwanted details in the image can strongly hamper the drift correction with a TWR if tiny movements occur in the image (i.e. thermal expansion) during the measurement. Very precise drift corrections (order of magnitude 1:10⁴) are however essential in FTIR or DRD systems in order to realize the necessary sensitivity.

Increasing the NA helps to reduce the influence of imperfections on the image, but there are many practical limitations. The solution that is presented in the following comprises the identification of the specific areas that suffer from defects and taking proper counteraction during the data analysis.

An essential feature of the proposed solution is to change the spatial distribution of the input light L1 emitted into the optical system 110. Such a change does not change the image of the object (object region 3) on the light detector 130, but the effect of disturbances outside the object region on said image. The useful application of this approach is strongly facilitated by the possibility to synchronize the light detector 130 and/or the evaluation unit 140 with the (rapid) variations in the input light.

The mentioned changes of the input light can preferably be generated with the help of a segmented light source, the segments of which can be addressed individually by a control unit 150. No moving parts are needed in this case. The principle of this method is to subdivide the light pencil L1 used for imaging in fractions that can be addressed separately.

A simple embodiment of the aforementioned principle is illustrated in FIGS. 1 and 2, where two adjacent rectangular LEDs 121 and 122 (e.g. on the same substrate) are used as a light source 120 in combination with a low-NA telecentric imaging system 110. There is no LED segmentation in the “vertical” direction, i.e. oblique to the object region 3, only in the “horizontal” direction (parallel to the object region 3). The LED segments 121, 122 can be switched on separately and/or simultaneously. In some applications a difference in wavelength and/or polarization of the light emission from the segments may be desirable. In the context of the sensor device 100, it is however assumed that the emissions from both segments 121, 122 have the same wavelength, intensity and polarization.

The image on the detector 130 of objects in the object plane 3 does not change by a switch from one light source segment to the other. The position of the image of a dust particle (e.g. indicated by a star between lens 111 and window 112) or a scratch on one of the windows, however, does depend on which of the LED segments 121, 122 is switched on. The image of such an imperfection will be somewhat out-of-focus, too, but the blur is limited due to the low effective NA corresponding with each LED segment. So, alternating the illumination between the two light source segments 121, 122 will cause a synchronized shifting pattern of out-of-focus dust particles at the detector. This indicates which pixels of the detector are unreliable as a result of imperfections in the light path. The method gets more effective for imperfections at a certain minimum distance from the object plane. The method also gets more effective if the effective NA represented by the individual light source segments is relatively low.

The simple embodiment of FIGS. 1 and 2, with two alternating light source segments 121 and 122, results in two alternating images on the light detector that show significant differences in position for the out-of-focus imperfections. The pixels at image positions that correspond to edges of imperfections will experience the strongest intensity fluctuations. In this way it is possible to determine even during a measurement which pixels are most strongly influenced by such imperfections in the light path. The signals of one or both light source segments can still be used for the normal measurement, but there now is the option to exclude suspected areas in the image from the signal evaluation.

In the sensor device 100 shown in FIGS. 1 and 2, the effective numerical aperture NA of the imaging for the total light source 120 is determined by the divergence θ of the rays at the position of object points A and B. The segmented light source P has an intermediate image P′ between the imaging lens 115 and the detector 130. It should be noted that the Figures are meant to be schematic, and that the effect of refraction at glass/plastic to air interfaces is not drawn in detail (it does slightly change the angles and divergences but not the effective NA).

Furthermore, the telecentricity of the imaging is not crucial. The principle of the method also applies to less telecentric imaging schemes. In case of a Koehler-like illumination, the imaging lens 115 should be sufficiently large to accommodate the intermediate image of all light source segments.

A low effective NA of the individual light source segments 121, 122 helps to localize imperfections in the image. The real measurement can however still be done with other or additional segments creating a larger effective NA to reduce the influence of the imperfections on the measurement. If a more complicated segmentation of the light source is used, it is possible to identify out-of-focus imperfections with two outer segments (low NA) and use a more central light source area (possibly higher NA) for the real measurement.

It can be useful to balance the averaged intensity of the images created by individual light source segments. This normalization can be realized in hardware (adjusting the LED segment currents) or in software (during the data handling).

The “reliability” of a pixel in the image may for example be determined by the relative difference

[I2−I1]/[I1+I2]

of the pixel intensities I1, I2 between images originating from LED segment 121 and 122, respectively. From the amplitude of shifts in the image, the distance of the imperfection to the object plane can be derived; the phase with respect to the illumination pattern reveals whether an imperfection is on the illumination or imaging side.

Another possible segmentation of a light source could be achieved by concentric rings (wherein the innermost disc of such a design may by definition be considered as a (degenerated) “ring”). The difference in the image between the illumination with an outer ring or a central disc segment is most pronounced for the pixels that correspond to the position of a dust particle.

The described method can also be exploited in a quality control measurement system to judge the quality (cleanliness) of the optical system or the cartridges. In addition, it can be used in real working conditions to support the data handling or to signal excessive contamination.

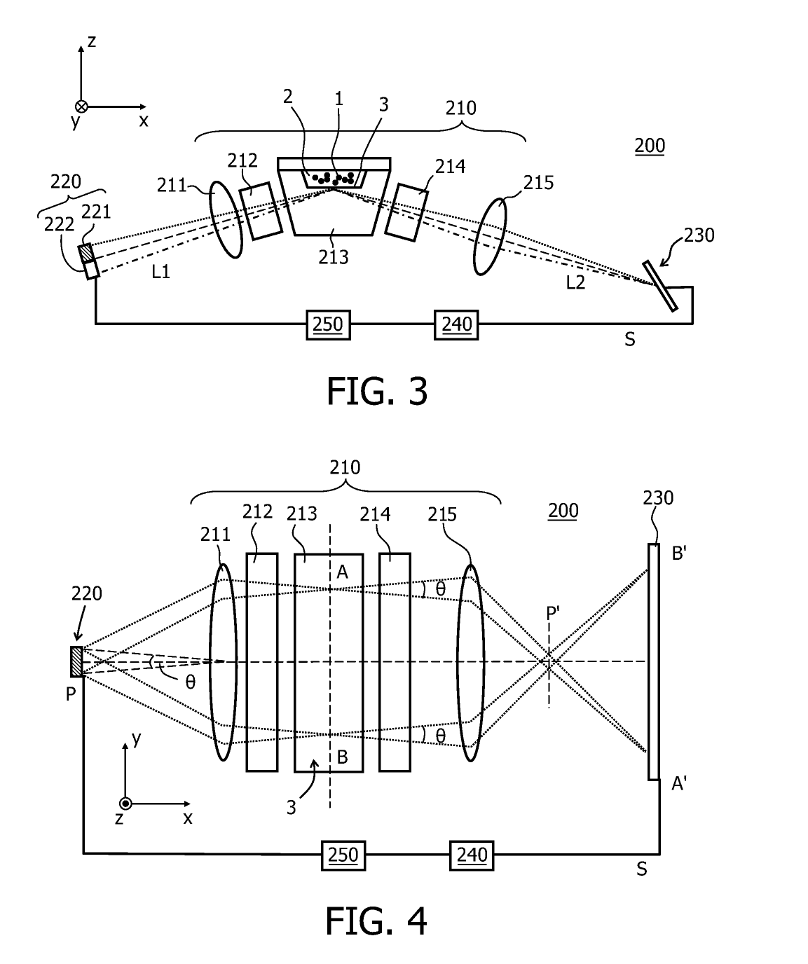

FIGS. 3 and 4 show a sensor device 200 according to a second embodiment of the invention. The shown views as well as the basic design of this sensor device are identical or similar to FIGS. 1 and 2. Hence they will not be described in detail again.

The main difference of sensor device 200 is that there is no segmentation of the light source 220 in the “horizontal” direction (parallel to the object region 3), but in the “vertical” direction (oblique to the object region). In this case the different segments 221, 222 of the light source 220 illuminate object region 3 under different FTIR (or DRD, . . . ) angles. So, alternating the illumination between the two light source segments 221 and 222 will cause a synchronized alternating FTIR angle at the detector.

This allows a change in FTIR angle without the use of moving parts. This also corresponds to a well defined variation in the evanescent field depth. As the alternating frequency can be rather high (e.g. 1000 Hz), it may give additional information on the target particles 1 close to the surface 3 (distance, size, Brownian motion, influence of magnetic actuation on position, etc).

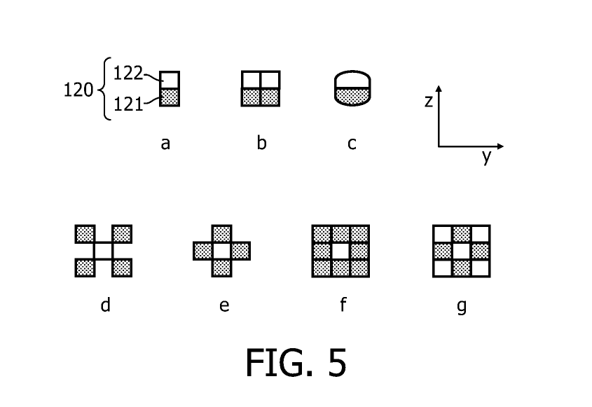

FIG. 5 illustrates different designs a) g) of a light source with an area that is segmented in a matrix pattern. Segments with the same hatching can commonly be addressed. The wavelength, intensity and polarization of the various segments can be identical.

Versions a), b) and c) of the shown light sources could (with a proper orientation) for instance be used to realize the light sources 120 or 220 of FIGS. 1-4.

Apart from the described embodiments, many other applications can be conceived that use the same principle of fluctuating spatial illumination pattern (e.g. produced by a segmented light source) in combination with synchronous detection. This can be applied to explore the influence of many different parameters without the need for moving parts in the optical light path, for example:
Polarization: If the various light source segments have different polarization, the effect of polarization may be exploited (yielding in an FTIR setup for example different evanescent wave field strength/penetration depth).
Wavelength: Using different wavelengths for the various light source segments offers the possibility to probe a biosensor spot with different evanescent wave field strength/penetration depth. In addition, specific particles may react differently on different wavelengths (absorption/fluorescence/scattering).
Numerical aperture NA: The use of concentric light source segments allows a quick change in the effective NA without the need for moving parts (e.g. diaphragms). This is another method to identify positions in the image that are influenced by imperfections in the light path. This more symmetric approach (of switching between a large light source area and a small central segment) can also be applied to the horizontal and vertical direction separately.

Combinations of the above effects are possible as well. In the most flexible embodiment, the light source would be a matrix color display allowing any pattern of segments with similar or different colors. A TN (Twisted-Nematic) cell could be added to allow an additional free choice of polarization.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. An optical sensor device comprising:
a light source with an area for emitting “input light” (L1), wherein the spatial distribution of the input-light emission from said area can selectively be changed;
an optical system through which said input light (L1) can propagate to yield an emission of “output light” (L2);
a light detector for detecting said output light (L2);
an evaluation unit for evaluating the detected output light (L2) while taking changes of the input light (L1) into account.

2. A method for making examinations with an optical sensor device, said method comprising the following steps:
emitting “input light” (L1) from a light emitting area to yield light source, wherein the spatial distribution of this input-light emission is selectively changed;
propagating said input light (L1) through an optical system to yield an emission of “output light” (L2);
detecting said output light (L2) with a light detector;
evaluating the detected output light (L2) with an evaluation unit while taking changes of the input light (L1) into account.

3. The sensor device (100, 200) according to claim 1,
characterized in that the sensor device comprises a control unit that is coupled to the light source and the evaluation unit.

4. The sensor device according to claim 1,
characterized in that the sensor device comprises a control unit that is adapted to repetitively switch between different patterns of light emission from the light emitting area.

5. The sensor device according to claim 1,
characterized in that the spatial distribution of the intensity, the wavelength and/or the polarization of the light emission from the light emitting area can be controlled.

6. The sensor device according to claim 1,
characterized in that the light source comprises a plurality of light emitting segments that can individually be controlled.

7. The sensor device according to claim 6,
characterized in that the segments are arranged in a matrix pattern and/or in concentric rings.

8. The sensor device according to claim 1,
characterized in that the optical system comprises an object region that is imaged onto the light detector.

9. The sensor device according to claim 8,
characterized in that the evaluation of the detected output light (L2) comprises the detection and/or the elimination of optical disturbances outside the object region.

10. The sensor device according to claim 8,
characterized in that the evaluation of the detected output light (L2) comprises the determination of the sensitivity of image parts to changes of the input light (L1).

11. The sensor device according to claim 1,
characterized in that the physical interaction of input light (L1) with a sample (1) depends on the changes of the input light (L1).

12. The sensor device according to claim 1,
characterized in that the input light (L1) is reflected, refracted, scattered and/or absorbed in the optical system.

13. The sensor device according to claim 12,
characterized in that the input light (L1) is totally internally reflected at an interface (3) in the optical system and/or that it is multiple times refracted at an interface with a prismatic structure.

14. The sensor device according to claim 1,
characterized in that the output light comprises light from a fluorescence that was stimulated by the input light.

15. Use of the sensor device according to claim 1 for molecular diagnostics, biological sample analysis, chemical sample analysis, food analysis, forensic analysis and/or quality control.
